(19) United States
(12) Patent Application Publication
(10) Pub. No.: US 2017/0322684 A1
(43) Pub. Date: Nov. 9, 2017

(54) Automation Of Clinical Scoring For Decision Support

(71) Applicant: Siemens Healthcare GmbH, Erlangen (DE)

(72) Inventors: Gerardo Hermosillo Valadez, West Chester, PA (US); Marcos Salganicoff, Bala Cynwyd, PA (US); Brian Delmonego, Chester Springs, PA (US); Penny Reiman, Pottstown, PA (US); Friedrich Fuchs, Hessdorf (DE)

(21) Appl. No.: 15/581,236

(22) Filed: Apr. 28, 2017

Related U.S. Application Data
(60) Provisional application No. 62/330,932, filed on May 3, 2016.

(51) Int. Cl. G06F 3/0482; G06F 19/00; G06N 99/00; G06T 11/60

(52) U.S. Cl. CPC G06F 3/0482; G06N 99/005; G06F 19/322; G06T 11/60; G06F 19/321; G06F 19/363; G06F 19/345; G06T 2200/24; G06T 2210/41

(57) ABSTRACT

A framework for automating clinical scoring for decision support is described herein. In accordance with one aspect, a patient record including corresponding medical image data is retrieved. The medical image data is processed to generate processed medical image data. A set of user interface screens is presented to guide a user through a clinical scoring questionnaire, wherein at least one of the user interface screens displays the processed medical image data. Responses to the clinical scoring questionnaire are received from the user via the set of user interface screens. A clinical score may be generated based at least in part on the responses. A clinical score report based on the clinical score may then be presented.

### CROSS-REFERENCE TO RELATED APPLICATION

The present application claims the benefit of U.S. provisional application No. 62/330,932 filed May 3, 2016, the entire contents of which are herein incorporated by reference.

### TECHNICAL FIELD

The present disclosure generally relates to data processing, and more particularly to automation of clinical scoring for decision support.

### BACKGROUND

Coronary artery disease (CAD) is one of the most common causes of death and disability globally. CAD occurs due to atherosclerotic narrowing of coronary arteries caused by coronary lesions. Limitation of blood and oxygen flow to the heart causes ischemia of the myocardial cells, which may lead to a myocardial infarction (i.e., a heart attack). Chronic high-grade stenosis of the coronary arteries can induce transient ischemia, which leads to induction of a ventricular arrhythmia that may terminate into ventricular fibrillation leading to death.

There are a number of treatment options for coronary artery disease. Procedures such as percutaneous coronary intervention (PCI) or coronary artery bypass graft surgery (CABG) may be used in severe diseases. PCI is a non-surgical procedure that involves balloon angioplasty with coronary stent placement and is typically performed in the catheter lab often immediately following coronary angiography. CABG is an open-heart surgery that is performed by cardiothoracic surgeons in an operating room while the patient is under general anesthesia.

Choosing the right therapy according to CAD complexity and long term outcome according to guidelines is very complex and difficult to achieve in practice. The appropriateness of any therapy depends on many factors. For example, PCI may be appropriate for patients with stable coronary artery disease if they meet certain criteria. However, increased lesion complexity is related to increased risk of adverse outcome of PCI.

### SUMMARY

Described herein are systems and methods for automating clinical scoring for decision support. In accordance with one aspect, a patient record including corresponding medical image data is retrieved. The medical image data is processed to generate processed medical image data. A set of user interface screens is presented to guide a user through a clinical scoring questionnaire, wherein at least one of the user interface screens displays the processed medical image data. Responses to the clinical scoring questionnaire are received from the user via the set of user interface screens. A clinical score may be generated based at least in part on the responses. A clinical score report based on the clinical score may then be presented.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

FIG. 1 is a block diagram illustrating an exemplary system;

FIG. 2 shows an exemplary method of automating clinical scoring;

FIG. 3 shows an exemplary user interface screen for selecting the dominance of an angiogram image;

FIG. 4 shows an exemplary chart for generating the SYNTAX scoring questionnaire;

FIG. 5a shows an exemplary user interface screen for specifying diseased segments for a particular lesion;

FIG. 5b shows an exemplary user interface screen for specifying presence of a total occlusion;

FIG. 6 shows an exemplary user interface screen for specifying total occlusion (T.0.) variables;

FIG. 7 shows an exemplary user interface screen for specifying additional T.O. variables;

FIG. 8 shows another exemplary user interface screen for specifying additional T.O. variables;

FIG. 9 shows an exemplary user interface screen for displaying a SYNTAX scoring summary report; and

FIG. 10 shows an exemplary user interface screen for displaying the SYNTAX score report.

### DETAILED DESCRIPTION

In the following description, numerous specific details are set forth such as examples of specific components, devices, methods, etc., in order to provide a thorough understanding of implementations of the present framework. It will be apparent, however, to one skilled in the art that these specific details need not be employed to practice implementations of the present framework. In other instances, well-known materials or methods have not been described in detail in order to avoid unnecessarily obscuring implementations of the present framework. While the present framework is susceptible to various modifications and alternative forms, specific embodiments thereof are shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention. Furthermore, for ease of understanding, certain method steps are delineated as separate steps; however, these separately delineated steps should not be construed as necessarily order dependent in their performance.

The term “x-ray image” as used herein may mean a visible x-ray image (e.g., displayed on a video screen) or a digital representation of an x-ray image (e.g., a file corresponding to the pixel output of an x-ray detector). The term “in-treatment x-ray image” as used herein may refer to images captured at any point in time during a treatment delivery phase of an interventional or therapeutic procedure, which may include times when the radiation source is either on or off. From time to time, for convenience of description, CT imaging data (e.g., cone-beam CT imaging data) may be used herein as an exemplary imaging modality. It will be appreciated, however, that data from any type of imaging modality including but not limited to x-ray radiographs, MRI, PET (positron emission tomography), PET-CT, SPECT, SPECT-CT, MR-PET, 3D ultrasound images or the like may also be used in various implementations.

Unless stated otherwise as apparent from the following discussion, it will be appreciated that terms such as “segmenting,” “generating,” “registering,” “determining,” “aligning,” “positioning,” “processing,” “computing,” “selecting,” “estimating,” “detecting,” “tracking” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, implementations of the present framework are not described with reference to any particular programming language. It will be appreciated that a variety of programming languages may be used.

As used herein, the term “image” refers to multi-dimensional data composed of discrete image elements (e.g., pixels for 2D images and voxels for 3D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R, or a mapping to R³, the present methods are not limited to such images, and can be applied to images of any dimension, e.g., a 2D picture or a 3D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

The terms “pixels” for picture elements, conventionally used with respect to 2D imaging and image display, and “voxels” for volume image elements, often used with respect to 3D imaging, can be used interchangeably. It should be noted that the 3D volume image is itself synthesized from image data obtained as pixels on a 2D sensor array and displays as a 2D image from some angle of view. Thus, 2D image processing and image analysis techniques can be applied to the 3D volume image data. In the description that follows, techniques described as operating upon pixels may alternately be described as operating upon the 3D voxel data that is stored and represented in the form of 2D pixel data for display. In the same way, techniques that operate upon voxel data can also be described as operating upon pixels. In the following description, the variable x is used to indicate a subject image element at a particular spatial location or, alternately considered, a subject pixel. The terms “subject pixel” or “subject voxel” are used to indicate a particular image element as it is operated upon using techniques described herein.

One method for evaluating a patient's coronary vasculature is the SYNTAX clinical scoring method. The SYNTAX scoring method is a clinically validated technique to score the complexity and severity of coronary artery disease, and is used to help decide whether patients should be treated with percutaneous coronary intervention (PCI) or coronary artery bypass graft (CABG). SYNTAX scoring, however, is a very time consuming process and generates increased workload, as it requires cardiologists to manually/visually evaluate angiograms, answer a long series of questions and assign a score based on each answer. In addition, the results of SYNTAX scoring are dependent on the cardiologist and vary based on how the cardiologist perceives and scores the angiogram images.

A framework for automating clinical scoring (e.g., SYNTAX) for decision support is described herein. In accordance with one aspect, a set of user interface screens is provided to guide the user through the clinical scoring (e.g., SYNTAX) process, thereby advantageously facilitating efficient workflow and data integration. During the clinical scoring process, coronary lesions may be categorized and various clinical variables, such as comorbidities, creatinine level, ejection fraction (EF) or age, may be determined and stored. The clinical score (e.g., SYNTAX score) may then be determined based on the variables, and used to evaluate the extent and complexity of the disease (e.g., coronary artery disease) and identify the most appropriate intervention (e.g., PCI or CABG). The present framework advantageously results in more efficient determination of the clinical score and more accurate matching of intervention to disease extent. As a result, it provides improved outcomes, lowers number of patient readmissions and reduces costs due to avoidable complications and subsequent revascularizations. These and other exemplary features and advantages will be described herein.

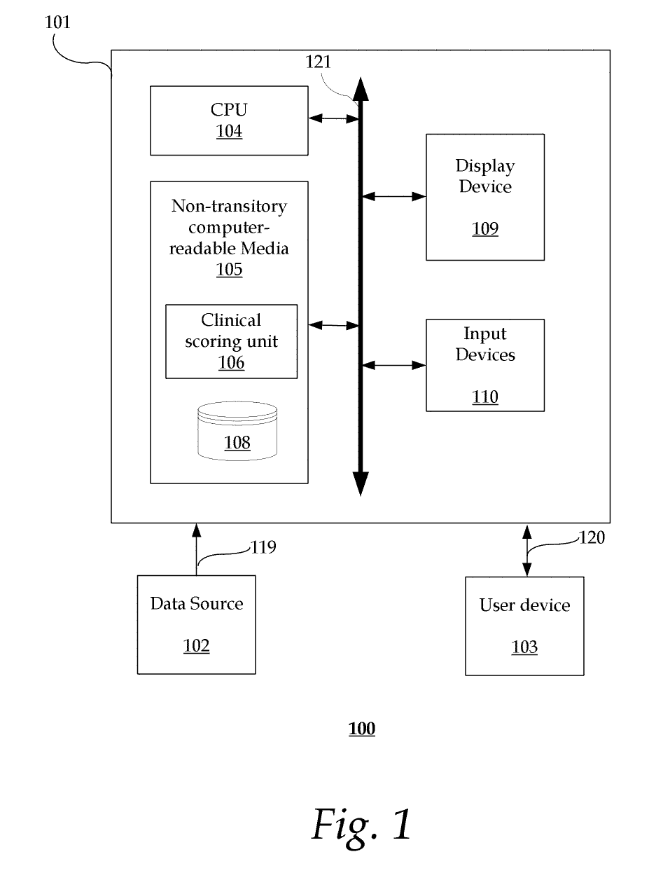

FIG. 1 is a block diagram illustrating an exemplary system 100. The system 100 includes a computer system 101 for implementing the framework as described herein. In some implementations, computer system 101 operates as a standalone device. In other implementations, computer system 101 may be connected (e.g., using a network) to other machines, such as user device 103. In a networked deployment, computer system 101 may operate in the capacity of a server (e.g., thin-client server, such as syngo.via® by Siemens Healthineers), a cloud computing platform, a client user machine in server-client user network environment, or as a peer machine in a peer-to-peer (or distributed) network environment.

In one implementation, computer system 101 comprises a processor or central processing unit (CPU) 104 coupled to one or more non-transitory computer-readable media 105 (e.g., computer storage or memory), display device 109 (e.g., monitor) and various input devices 110 (e.g., mouse or keyboard) via an input-output interface 121. Computer system 101 may further include support circuits such as a cache, a power supply, clock circuits and a communications bus. Various other peripheral devices, such as additional data storage devices and printing devices, may also be connected to the computer system 101.

The present technology may be implemented in various forms of hardware, software, firmware, special purpose processors, or a combination thereof, either as part of the microinstruction code or as part of an application program or software product, or a combination thereof, which is executed via the operating system. In one implementation, the techniques described herein are implemented as computer-readable program code tangibly embodied in non-transitory computer-readable media 105. In particular, the present techniques may be implemented by clinical scoring unit 106. Clinical scoring unit 106 may be a standalone component or integrated with another system, such as an electronic medical records (EMR) system.

Non-transitory computer-readable media 105 may include random access memory (RAM), read-only memory (ROM), magnetic floppy disk, flash memory, and other types of memories, or a combination thereof. The computer-readable program code is executed by CPU 104 to process data. As such, the computer system 101 is a general-purpose computer system that becomes a specific purpose computer system when executing the computer-readable program code. The computer-readable program code is not intended to be limited to any particular programming language and implementation thereof. It will be appreciated that a variety of programming languages and coding thereof may be used to implement the teachings of the disclosure contained herein.

The same or different computer-readable media 105 may be used for storing a database (or dataset) 108. Such data may also be stored in external storage or other memories. The external storage may be implemented using a database management system (DBMS) managed by the CPU 104 and residing on a memory, such as a hard disk, RAM, or removable media. The external storage may be implemented on one or more additional computer systems. For example, the external storage may include a data warehouse system residing on a separate computer system, a picture archiving and communication system (PACS), or any other now known or later developed hospital, medical institution, medical office, testing facility, pharmacy or other medical patient record storage system.

The data source 102 may provide data 119 for processing by clinical scoring unit 106. Such data may include patient records, such as radiology reports, labeled image data, angiographic variables, prior examination reports, diagnostic data, medications, risk factors, and/or other patient-specific information (e.g., baseline characteristics). Such data may be processed by clinical scoring unit 106 and stored in database 108. Data source 102 may be a computer, memory device, a radiology scanner (e.g., X-ray or a CT scanner) and/or appropriate peripherals (e.g., keyboard and display device) for acquiring, inputting, collecting, generating and/or storing such data.

User device 103 may include a computer (e.g., mobile computing device) and appropriate peripherals, such as a keyboard and display device, and can be operated in conjunction with the entire system 100. User device 103 may include, for example, an App that presents a graphical user interface generated by clinical scoring unit 106 and collects input data 120 for manipulating data processing by clinical scoring unit 106. User input data may be received via an input device (e.g., keyboard, mouse, touch screen, voice or video recognition interface, etc.) implemented in the user device 103.

It is to be further understood that, because some of the constituent system components and method steps depicted in the accompanying figures can be implemented in software, the actual connections between the systems components (or the process steps) may differ depending upon the manner in which the present framework is programmed. Given the teachings provided herein, one of ordinary skill in the related art will be able to contemplate these and similar implementations or configurations of the present framework.

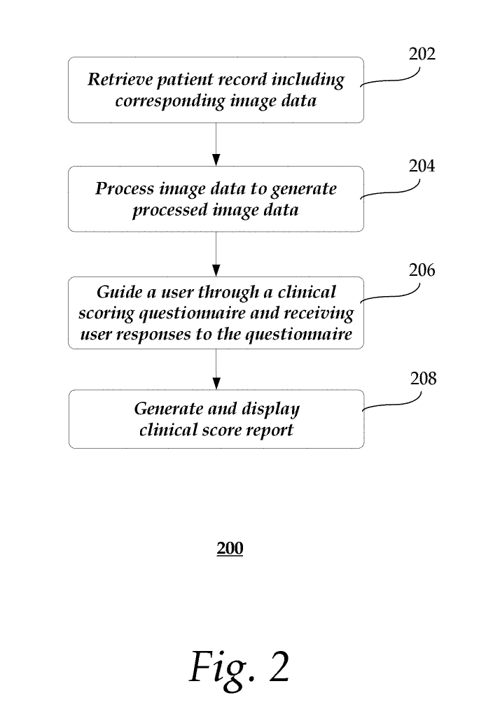

FIG. 2 shows an exemplary method 200 of automating clinical scoring by a computer system. It should be understood that the steps of the method 200 may be performed in the order shown or a different order. Additional, different, or fewer steps may also be provided. Further, the method 200 may be implemented with the system 101 of FIG. 1, a different system, or a combination thereof

At 202, clinical scoring unit 106 retrieves a patient record including corresponding medical image data. The patient record of an existing patient may be retrieved from database 108 or from data source 102. Alternatively, a record of a new patient may be acquired via user device 103. The patient record may be retrieved or acquired in response to a user selection received via a user interface screen at user device 103. The user interface screen may be generated by an App on user device 103 that is communicatively coupled to clinical scoring unit 106.

At 204, clinical scoring unit 106 processes the medical image data to generate processed medical image data. In some implementations, clinical scoring unit 106 processes the medical image data by labeling the medical image data and/or identifying dominance (e.g., left, right) of the medical image data. In some implementations, clinical scoring unit 106 generates a diagram based on the medical image data, and automatically labels segments (e.g., RCA proximal, RCA mid, RCA distal, etc.) of the coronary tree in the diagram. The coronary tree may be identified as right or left dominant. Alternatively, the diagram may be pre-labeled and/or pre-identified.

To automatically label the segments in the diagram, clinical scoring unit 106 uses an automated image segmentation algorithm. Machine learning algorithms may be used to compare the patient anatomy in the diagram to a database of images of other patients to identify dominance based on vessel sizes and positions. Dominance refers to whether the posterior descending artery (PDA) originates from the right coronary artery or RCA (right dominant), left coronary artery or LCX (left dominant), or both (codominant). The diagram may be identified as right dominant when the distal RCA is at the level of the crux of the heart and bifurcates into the PDA and a posterolateral branch. The PDA courses in the posterior ventricular septum giving origin to the SA nodal artery and posterior ventricular branch. Left dominance may be identified when the posterior descending artery is a branch of the distal left coronary artery (LCX). In co-dominance, there are right and left PDAs originating from the RCA and LCX.

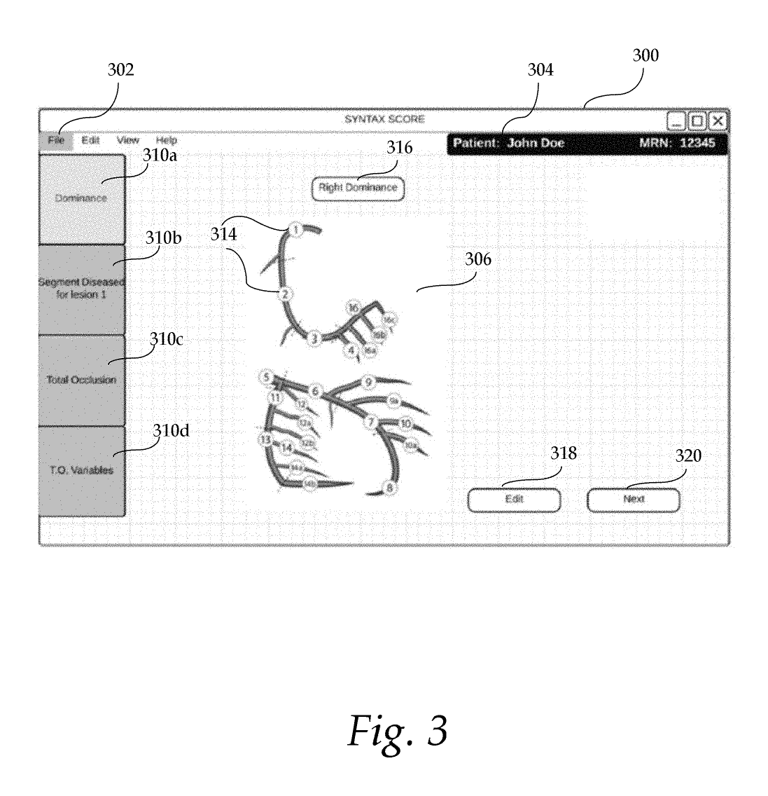

FIG. 3 shows an exemplary user interface screen 300 for selecting the dominance of an angiogram image. The user interface screen 300 includes a menu item 302 that the user can select to open a patient record file. Information (e.g., name, medical record number) 304 of the patient may be extracted from the patient record file and displayed at sub-section (e.g., right side) of the user interface screen 300 to provide patient context. Additionally, a coronary diagram 306 associated with the patient record may be displayed at another sub-section (e.g., center) of the user interface screen 300. The diagram 306 may be, for example, a coronary tree diagram derived from a coronary angiogram image.

A menu 310a-d may be displayed at a sub-section (e.g., left side) of the user interface screen 300. The menu 310a-d provides graphical user interface elements (e.g., 4 buttons) that correspond to simplified questions or steps (e.g., dominance, segment diseased lesion 1, total occlusion or T.O., T.O. variables of lesion 1) of the clinical scoring process to guide the user through the clinical scoring process. The graphical user interface element 310a may be displayed in a color corresponding to the labeling confidence level (e.g., green when confidence level is high). The labeling confidence level may be provided by the labeling algorithm or by the user.

As shown in FIG. 3, the diagram 306 is displayed with the identified reference labels 314 and dominance 316. The reference labels 314 may include standardized numerals that indicate the different segments of the coronary artery tree. The user may edit the labeling and/or identification by selecting the graphical user interface element (e.g., button) 318. The user may proceed to the next step of the SYNTAX scoring process by selecting graphical user interface element (e.g., button) 320.

Returning to FIG. 2, at 206, clinical scoring unit 106 guides the user through the clinical scoring questionnaire via other user interface screens and receives user responses to the questionnaire. The clinical scoring questionnaire may be a SYNTAX scoring questionnaire or any other standardized scoring questionnaire. One or more of the user interface screens display the processed medical image data (e.g., labeled diagram, identified dominance) and/or information extracted from the patient record to provide patient context and enable ease of comparison for the clinical scoring questionnaire.

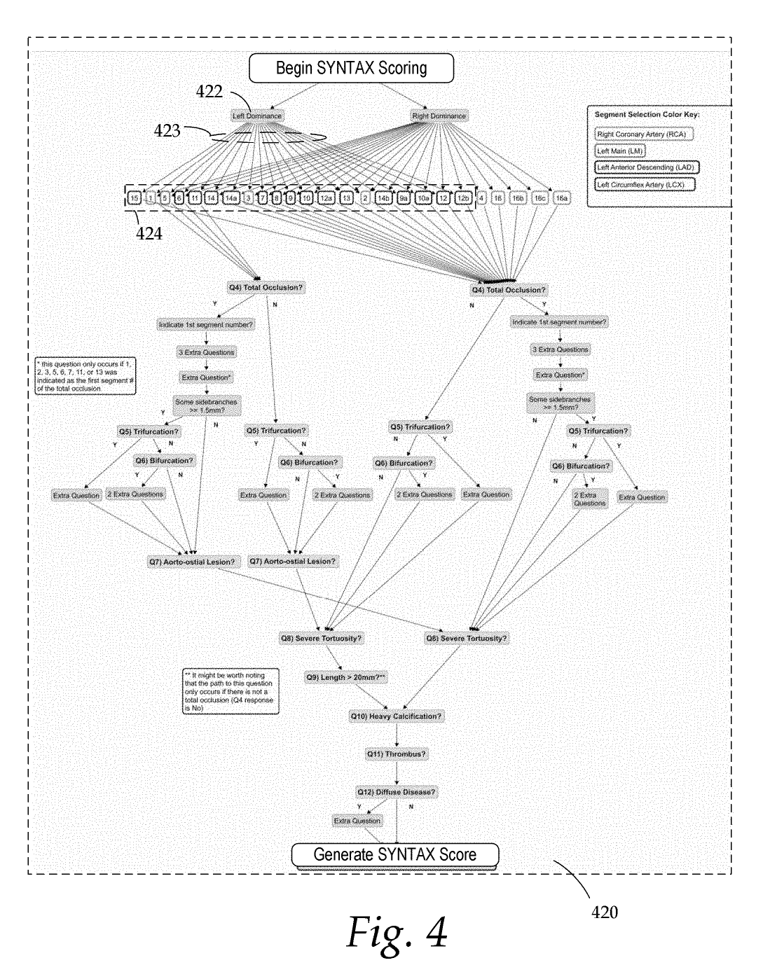

FIG. 4 shows an exemplary chart 420 for generating the SYNTAX scoring questionnaire. The questions in the questionnaire are provided along a path starting from the “Begin SYNTAX Scoring” node to the “Generate SYNTAX Score” node. The path is determined by the responses from a previous level. For example, in response to identifying left dominance 422, the path will traverse from node 422 along the arrows 423 to the next level nodes 424. In response to determining which segments (e.g., right coronary artery, left main, left anterior descending, left circumflex artery) are diseased in association with a particular lesion, the path will traverse along one of the arrows to the next level nodes, and so forth. Questions that may be extracted along the path may include, but are not limited to, “Is there total occlusion?”, “What is the first segment number?”, “Is there trifurcation?”, “Is there bifurcation?”, “Is it an aorta-ostial lesion?”, “Is there severe tortuosity?”, “Is the length greater that 20 mm?”, “Is there heavy calcification?”, “Is there thrombus?”, “Is there diffuse disease?”, and/or other extra questions. The SYTAX score may then be generated based on the responses to these questions.

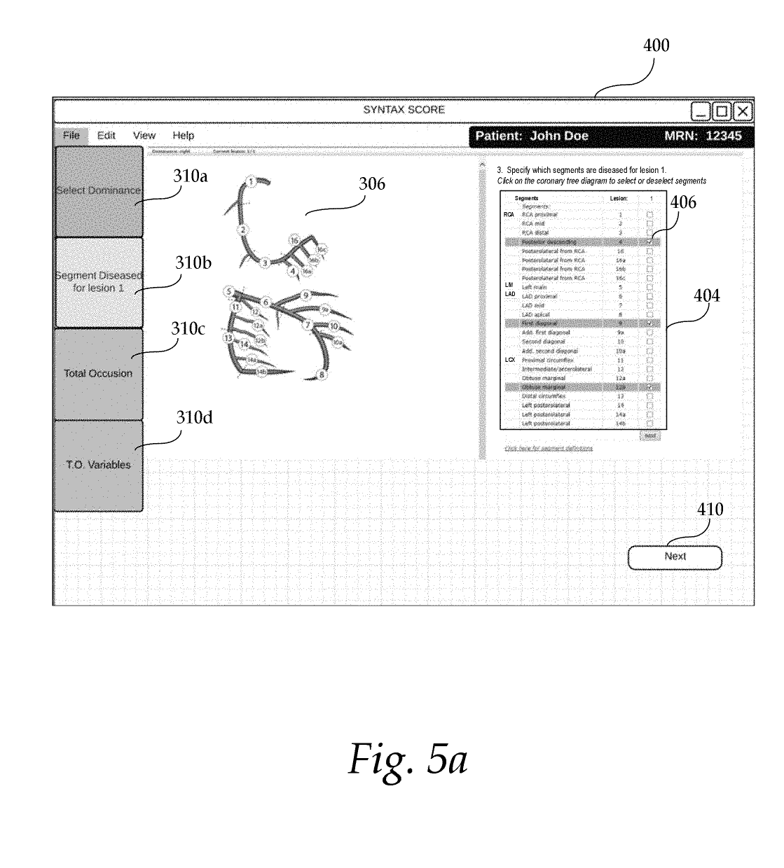

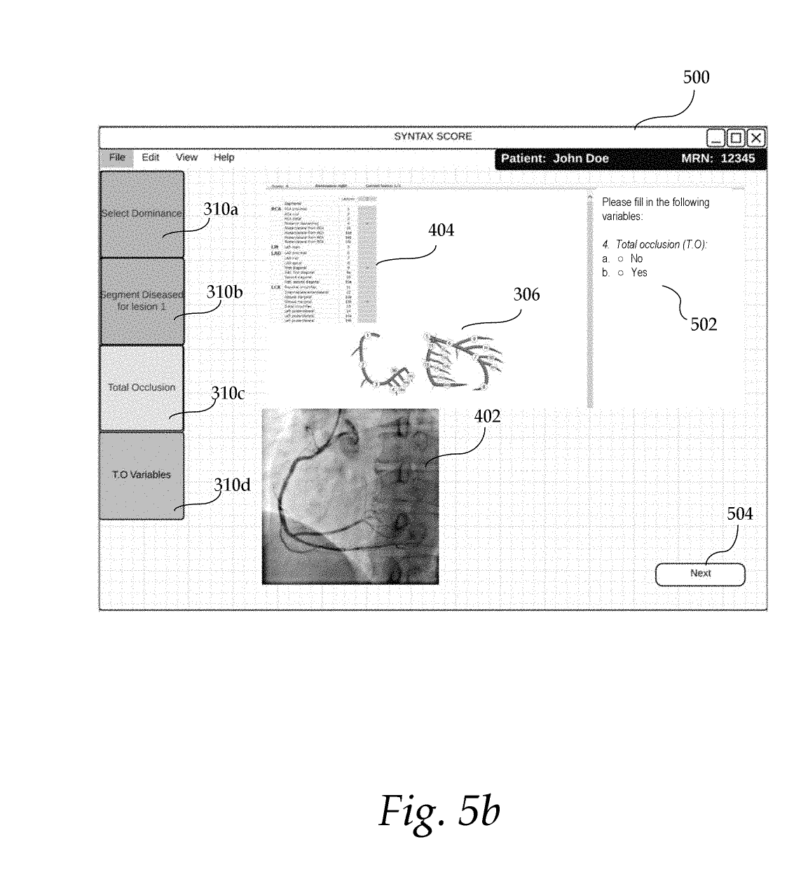

FIG. 5a shows an exemplary user interface screen 400 for specifying diseased segments for a particular lesion. This step identifies which segments of the coronary artery tree are diseased for each lesion (e.g., lesion 1). A table 404 is displayed in a sub-section (e.g., right side) of the user interface screen 400 next to the diagram 306 to enable ease of comparison. The table indicates which segments of the coronary tree are diseased for each lesion. Clinical scoring unit 106 may automatically compute and fill the table with the appropriate values. The values may be automatically computed by applying, for example, image analysis algorithms. Alternatively, the values may be acquired or computed by other systems and sent to the clinical scoring unit 106 to be combined with automated findings. The user may change the values by selecting or deselecting the user interface elements (e.g., check boxes or radio buttons) 406 to show diseased coronary tree segments and/or the segment in the diagram 306. The user may then proceed to the next step of the scoring process by selecting graphical user interface element (e.g., button) 410.

FIG. 5b shows an exemplary user interface screen 500 for specifying presence of total occlusion. A questionnaire 502 is displayed in a sub-section (e.g., right side) of the user interface screen 500 to enable the user to enter values for one or more variables (e.g., total occlusion). As shown, the variable may be a binary variable, wherein the user can select whether there is total occlusion or not. The diagram 306, table 404 and image 402 from previous steps may be displayed next to the questionnaire 502 to provide easy reference. After entering the value for the variable, the user may then proceed to the next step of the clinical scoring process by selecting the user interface element (e.g., button) 504.

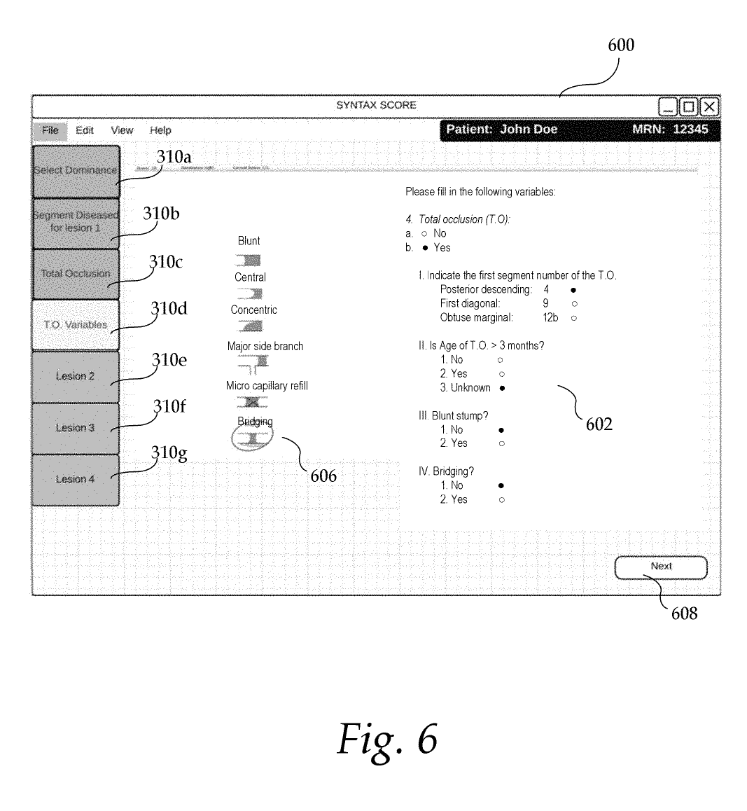

FIG. 6 shows an exemplary user interface screen 600 for specifying T.O. variables. In response to the user selecting that total occlusion is present, an expanded questionnaire 602 is displayed in a sub-section (e.g., right side) of the user interface screen 600 to enable the user to specify values for one or more T.O. variables (e.g., segment number of T.O., age of T.O., type of T.O. such as blunt, central, concentric, major side branch, micro capillary refill, bridging) in response to selecting that total occlusion is present. A diagram 606 of the different types of T.O. may be displayed next to the questionnaire 602 to facilitate the selection of the type of T.O. The left menu 310a-g is expanded as additional lesions (e.g., lesion 2, 3 and 4) are identified. The color of the user interface element 310d representing a corresponding step (e.g., entering T.O. variables) of the clinical scoring process may be changed (e.g., green to yellow) to indicate that confidence level is reduced. The confidence level may be provided by the measurement algorithm or by the user. After entering the values for the T.O. variables, the user may then proceed to the next step of the clinical scoring process by selecting the graphical user interface element (e.g., button) 608.

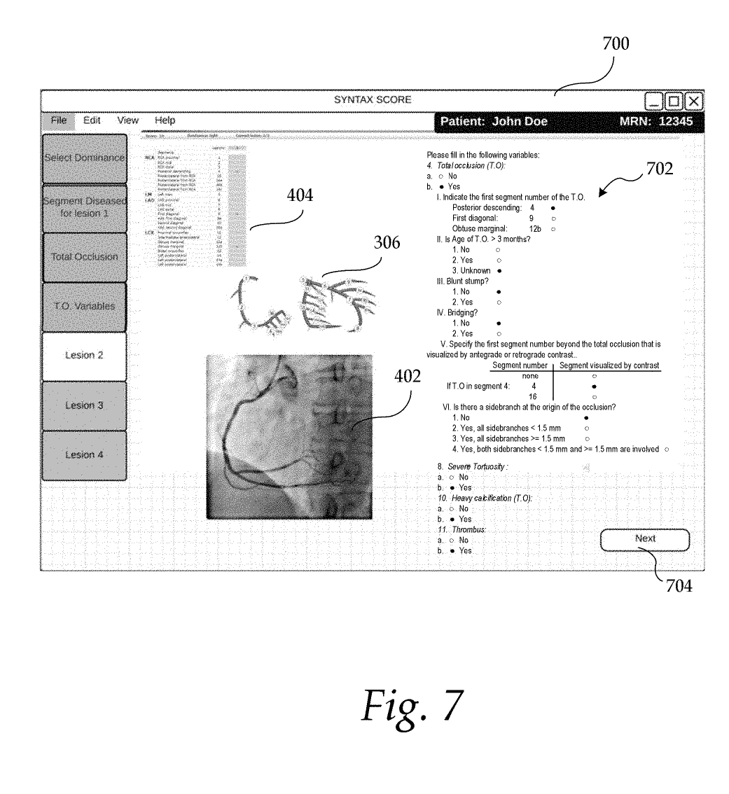

FIG. 7 shows an exemplary user interface screen 700 for specifying additional T.O. variables. An expanded questionnaire 702 is displayed in a sub-section (e.g., right side) of the user interface screen 700 to enable the user to specify values for additional T.O. variables (e.g., severe tortuosity, heavy calcification, thrombus). The diagram 306, table 404 and image 402 from previous steps may be displayed next to the questionnaire 702 to enable easy reference by the user. After entering the values for the T.O. variables, the user may then proceed to the next step of the clinical scoring process by selecting the user interface element (e.g., button) 704.

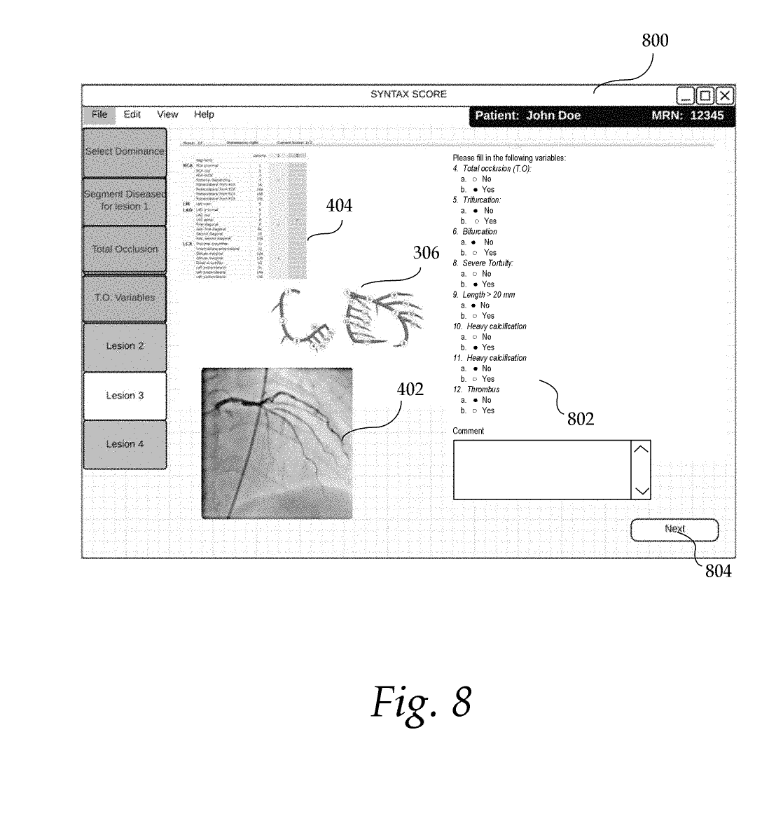

FIG. 8 shows another exemplary user interface screen 800 for specifying additional T.O. variables. A questionnaire 802 is displayed in a sub-section (e.g., right side) of the user interface screen 800 to enable the user to specify values for T.O. variables (e.g., severe tortuosity, heavy calcification, thrombus). The diagram 306, table 404 and image 402 from previous steps may be displayed next to the questionnaire 802 to enable easy reference by the user. After entering the values for the T.O. variables, the user may then proceed to the next step of the clinical scoring process by selecting the user interface element (e.g., button) 804.

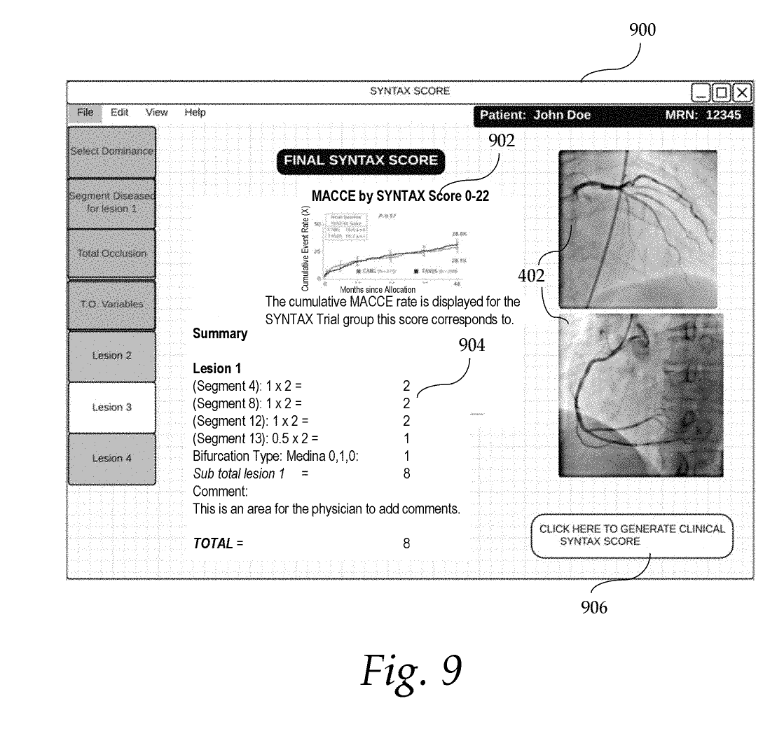

FIG. 9 shows an exemplary user interface screen 900 for displaying a SYNTAX clinical scoring summary report. The SYNTAX scoring summary report includes a graph 902 showing a cumulative Major Adverse Cardiac and Cerebrovascular event (MACCE) rate over several months, a summary 904 of the scores assigned to the different variables and the associated angiogram images 402. The user may initiate the calculation of the SYNTAX score by selecting the user interface element (e.g., button) 906.

Returning to FIG. 2, at 208, clinical scoring unit 106 generates and displays the clinical score report. In response to the user selecting user interface element 906 (shown in FIG. 9), the clinical scoring unit 106 automatically calculates the SYNTAX score based at least in part on the user responses to the questionnaire (e.g., T.O variable values). Patient clinical data (e.g., medical, family and/or social history, medications) may also be pre-fetched to generate the SYNTAX score report. A recommendation may be generated by mapping the SYNTAX score to a therapy (e.g., PCI or CABG) according to standardized guidelines.

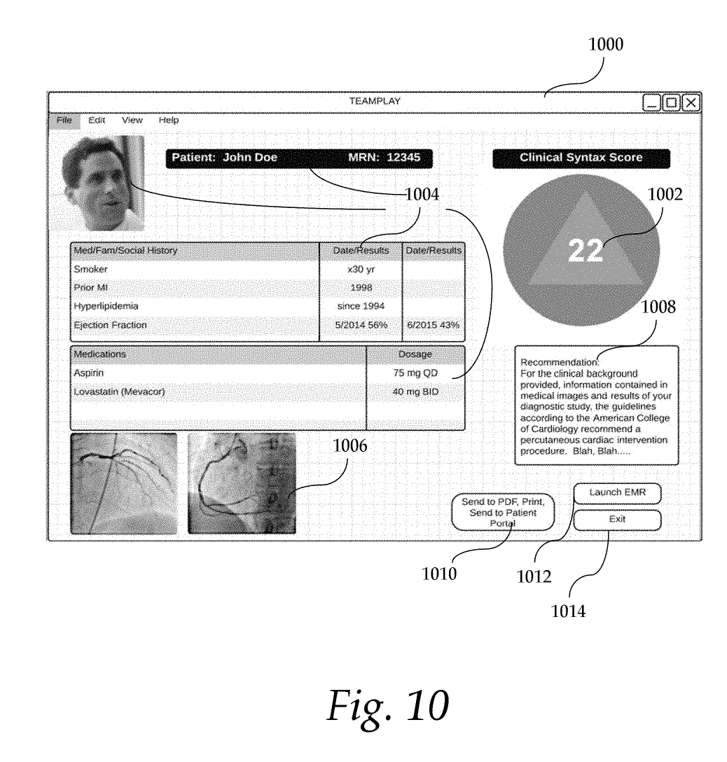

FIG. 10 shows an exemplary user interface screen 1000 for displaying the SYNTAX score report. The SYNTAX score report includes the clinical SYNTAX score 1002, patient data 1004 (e.g., patient's photograph, name, medical record number or identifier, medical, family and/or social history, medications) extracted from the patient record, key angiogram images 1006 and recommendation 1008 for therapy. Clinical scoring unit 106 may automatically generate the recommendation 1008 based on the SYNTAX score according to standardized guidelines (e.g., American College of Cardiology guidelines). The recommendation 1008 specifies a recommended therapy or intervention (e.g., PCI or CABG).

The SYNTAX score report may also be customized to present to the patient. The user may send the report to print as a portable document format file or printed document, or to a patient portal by selecting user interface element 1010 (e.g., button). The user may launch and send the SYNTAX score report to the electronic medical records (EMR) system by selecting user interface element 1012 (e.g., button). The user may further exit from the SYNTAX scoring application by selecting user interface element 1014 (e.g., button).

While the present framework has been described in detail with reference to exemplary embodiments, those skilled in the art will appreciate that various modifications and substitutions can be made thereto without departing from the spirit and scope of the invention as set forth in the appended claims. For example, elements and/or features of different exemplary embodiments may be combined with each other and/or substituted for each other within the scope of this disclosure and appended claims.

What is claimed is:

1. A system for automating clinical scoring, comprising:
a non-transitory memory device for storing computer readable program code; and
a processor in communication with the memory device, the processor being operative with the computer readable program code to perform operations including
retrieving a patient record including corresponding image data,
labeling coronary segments in a diagram derived from the image data,
identifying dominance of the diagram,
presenting a set of user interface screens to guide a user through a SYNTAX scoring questionnaire, wherein at least one of the user interface screens displays the labeled diagram and the identified dominance,
receiving, via the set of user interface screens, responses to the SYNTAX scoring questionnaire from the user, and
generating a SYNTAX score based at least in part on the responses and displaying a SYNTAX score report based on the SYNTAX score.

2. The system of claim 1 wherein the processor is operative with the computer readable program code to display a menu in the user interface screens that includes graphical user interface elements corresponding to steps in the SYNTAX scoring questionnaire.

3. The system of claim 2 wherein at least one of the graphical user interface elements is displayed in a color corresponding to a confidence level.

4. The system of claim 1 wherein the questionnaire comprises questions regarding variables related to a total occlusion displayed in response to receiving a user selection indicating that the total occlusion is present.

5. The system of claim 1 wherein the processor is operative with the computer readable program code to further generate a recommendation by mapping the SYNTAX score to a therapy.

6. A method, comprising:
retrieving a patient record including corresponding medical image data;
processing the medical image data to generate processed medical image data;
presenting a set of user interface screens to guide a user through a clinical scoring questionnaire, wherein at least one of the user interface screens displays the processed medical image data;
receiving, via the set of user interface screens, responses to the clinical scoring questionnaire from the user; and
generating a clinical score based at least in part on the responses and displaying a clinical score report based on the clinical score.

7. The method of claim 6 wherein generating the clinical score comprises generating a SYNTAX score.

8. The method of claim 6 wherein processing the medical image data comprises labeling the medical image data to identify segments of a coronary tree in a coronary tree diagram derived from a coronary angiogram image.

9. The method of claim 6 wherein processing the medical image data comprises identifying dominance of the medical image data.

10. The method of claim 6 wherein presenting the set of user interface screens comprises displaying a menu in the user interface screens that includes graphical user interface elements corresponding to steps in the clinical scoring questionnaire.

11. The method of claim 10 further comprises displaying at least one of the graphical user interface elements in a color corresponding to a confidence level.

12. The method of claim 6 wherein presenting the set of user interface screens comprises displaying an angiogram image next to a corresponding labeled diagram of a coronary tree in at least one of the set of user interface screens.

13. The method of claim 12 further comprises displaying a table indicating which segments of the coronary tree are diseased.

14. The method of claim 6 wherein the questionnaire comprises questions regarding a total occlusion.

15. The method of claim 14 wherein the questionnaire comprises questions regarding variables related to the total occlusion displayed in response to receiving a user selection indicating that the total occlusion is present.

16. The method of claim 15 wherein the variables comprise a segment number of the total occlusion, an age of the total occlusion, a type of the total occlusion, or a combination thereof.

17. The method of claim 6 further comprises displaying a clinical scoring summary report including a summary of scores assigned to different variables and one or more angiogram images.

18. The method of claim 6 further comprises generating a recommendation by mapping the clinical score to a therapy.

19. The method of claim 6 wherein displaying the clinical score report comprises displaying the clinical score, patient data extracted from the patient record, one or more key angiogram images and a recommendation for therapy.

20. One or more non-transitory computer readable media embodying a program of instructions executable by machine to perform operations, the operations comprising:
retrieving a patient record including corresponding medical image data;
processing the medical image data to generate processed medical image data;
presenting a set of user interface screens to guide a user through a clinical scoring questionnaire, wherein at least one of the user interface screens displays the processed medical image data;
receiving, via the set of user interface screens, responses to the clinical scoring questionnaire from the user; and
generating a clinical score based at least in part on the responses and presenting a clinical score report based on the clinical score.
